(19) United States
(12) Patent Application Publication
(10) Pub. No.: US 2006/0165034 A1
(43) Pub. Date: Jul. 27, 2006

(54) Cover resource adapter

(75) Inventor: Gabor Pecsy, Budapest (HU)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/042,605

(22) Filed: Jan. 25, 2005

(51) Int. Cl. H04Q 7/00

(52) U.S. Cl. 370/329

(57) ABSTRACT

A method, device and computer code product for enabling communication between electronic devices. A covered resource adapter receives information describing each association of a covered resource adapter message driven bean with a corresponding resource adapter. Each covered resource adapter message driven bean is decoupled from its corresponding resource adapter, and the covered resource adapter collects all similar resource adapters. The covered resource adapter creates a virtual association between similar resource adapters and an application message driven bean, and an application message driven bean transmits data to a client application.

### FIELD OF THE INVENTION

The present invention relates to middleware compatible with the Java platform. More particularly, the present invention relates to methods, a device and a computer program product for creating a design pattern compatible with the Java platform.

### BACKGROUND OF THE INVENTION

One of the advantages of mobile communications is the ability to access networks and applications that are located within those networks while maintaining mobility. In order to ensure that the network and application can communicate, efficient and competent middleware must be developed. Middleware is software which facilitates interoperability between often-conflicting network and application protocols. Nokia Mobility Middleware (NMM) is a suite of Java 2 platform, Enterprise Edition (J2EE) components that provide functionality enabling communication between the network and applications. The functionality that NMM provides has a particular emphasis on functionality used by mobile terminals, e.g. short messaging service (SMS) and multimedia messaging service (MMS).

The Java 2 platform, Enterprise Edition (J2EE) is a standard for developing component-based applications. The J2EE Connector Architecture (JCA) defines a way to integrate J2EE application servers with different Enterprise Information Systems (EIS) such as database management systems, short messaging service centres (SMSCs), multimedia messaging service centres (MMSCs), EISs which utilize Systems, Applications and Products in data processing (SAP) software, etc. JCA 1.5 is the latest version of JCA and is part of the J2EE 1.4 specification.

Resource adapters (RA) are JCA-compliant connectivity components which can connect application servers that utilize the J2EE protocol to different EISs. Therefore, connectivity between a network and application servers such as SMSCs and MMSCs can be realized using RAs.

Currently, the NMM messaging feature includes support for three different SMS messaging protocols and two MMS messaging protocols. Each protocol can be implemented in an RA. In J2EE applications, the technology for handling asynchronous events (such as an incoming message) is Message Driven Beans (MDBs). In order to receive messages, the SMS or MMS application must implement special objects i.e. MDBs and associate each MDB with a corresponding RA. One MDB per RA is needed since, in the current J2EE architecture, only RAs can pass messages to an MDB. Accordingly, in current systems, the SMSC or MMSC must have an accurate count of the number of RAs in the system. Therefore, installing additional RAs in the system later can be problematic as this hampers the ability of an application server to have an accurate count of the RAs in the system.

Currently, RAs are not hidden from the application since RAs interact directly with MDBs, which interact with applications. Therefore, RAs are required to be compatible with the application and must expend processing power to separately process incoming data from different protocols in different applications. RAs and mobile terminals must also be updated each time that an application protocol is updated.

Currently, in a clustered deployment of a J2EE application server, in which a set of different processes are potentially running on different machines or nodes but accessing the same EIS, an RA must be associated with each node. This can be problematic since in some cases, the EIS is controlled by a third-party that has placed a limit on the number of RAs that can connect to it. This limits the number of nodes that can be included in the cluster and accordingly limits the benefits of clustering, which include scalability and an increased availability of resources. Current design patterns such as the Facade and the Proxy design patterns fail to provide clustering benefits.

Thus, there is a need for a design pattern that can reduce application processing by reducing the need to maintain an accurate count of each RA in the system, and correspondingly allows for the seamless addition of RAs to a system. There is also a need for a design pattern which allows for seamless modification and addition of new protocols in the applications. There is also a need for a design pattern which can reduce the amount of processing power expended by the RA and the mobile terminal by hiding the different protocols by which incoming data arrives. Finally, there is a need for a design pattern which allows a system to obtain the full benefits of clustering in J2EE clustered deployment.

### SUMMARY OF THE INVENTION

The present invention is directed to a method, device and a computer program product for a JCA 1.5-compliant cover resource adapter (CRA) design pattern which can collect and hide a number of resource adapters (RAs) by creating a single virtual resource adapter. Accordingly, the CRA can make application development and management less complex since the client application need only interact with the CRA, as opposed to interacting with multiple RA components.

The CRA alleviates the need for an application to maintain an accurate count of each RA in the system. Accordingly, the CRA allows additional RAs to be added to the network seamlessly. The CRA can also allow reduced processing at the RAs and mobile terminals by hiding the protocols by which data arrives, enabling the seamless addition of new and different protocols in the applications. The CRA can also enable receipt of the full benefits of clustering in clustered J2EE deployment by reducing the number of RAs that the EIS perceives as attached, thereby allowing an increased number of RAs to attach to the application. The CRA also enables the realization of different RA clustering schemes. In clustered J2EE deployment, CRAs also make the client less susceptible to artificial limits that a third-party EIS may place on the number of connections that can be made to the EIS.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 shows a system in which the present invention can be utilized, comprising multiple communication devices that can communicate through a network;

FIG. 2 shows a system in which the present invention can be employed utilizing the covered resource adapter;

FIG. 3 shows a system in which the present invention can be employed utilizing a clustered J2EE deployment;

FIG. 4 shows a flow chart illustrating communication between an application server and one or more Enterprise Information Systems utilizing the covered resource adapter;

FIG. 5 shows a device in which the present invention can be employed utilizing the covered resource adapter; and

FIG. 6 shows a flow chart illustrating communication between an application server and one or more Enterprise Information Systems using clustered J2EE deployment and the covered resource adapter design pattern according to an embodiment of the present invention.

### DETAILED DESCRIPTION OF THE PREFERRED EMBODIMENTS

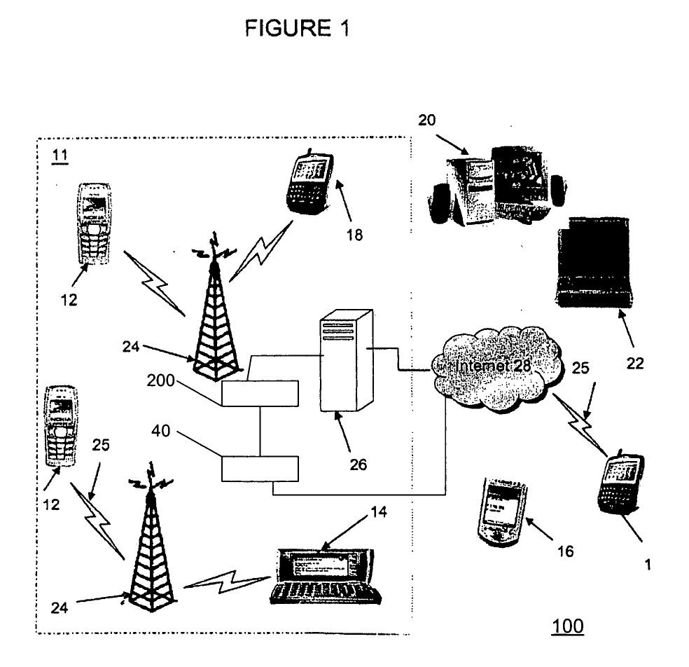

FIG. 1 shows a system 100 in which the present invention can be utilized, comprising multiple communication devices that can communicate through a network. The system 100 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 100 can include both wired and wireless communication devices.

For exemplification, the system 100 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The Internet 28 may include an enterprise application 30, written according to J2EE specifications in one embodiment of the invention, which runs on top of an application server and is disposed to carry out processing in order to perform a specific function for the mobile terminal. In an embodiment of the present invention, functions may include, but are not limited to, those utilizing with messaging applications and authentication of the mobile terminal. The enterprise application 30 may be operatively connected to a device which contains a processor to implement the functionality of a covered resource adapter design pattern 32 (“Covered Resource Adapter” i.e. “CRA”). The application server serves as a contain for both the resource adapter (whether covered or not) and the enterprise application 30 and manages their life cycle, interactions, etc.

The CRA 32 may be connected to the enterprise application 30 and application server via a device which contains a processor to implement the functionality of a message driven bean object 34 (“Application Message Driven Bean” i.e. “APP MDB”). The CRA 32 may also be connected to one or more devices which contain a processor to implement the functionality of message driven bean objects for corresponding resource adapters 36 (“Covered Resource Adapter Message Driven Bean” i.e. “CRA MDB”). The CRA 32 operates in a like fashion to that of the resource adapters, whose operation is dictated according to the J2EE Connector Architecture Specification, version 1.5.

Each CRA MDB 36 may be connected to a device which contains a processor to implement the functionality of a corresponding resource adapter 38 (“Resource Adapter” i.e. “RA”). Each RA 38 may be connected to a corresponding device which contains a processor to implement the functionality of an Enterprise Information System 40 (“Enterprise Information System” i.e. “EIS”). EISs may include, but are not limited to, systems such as SAP, database management systems, SMSCs and MSMCs. The CRA 32, APP MDB 34, CRA MDB 36, RA 38 and EIS 40 may be implemented in hardware or software.

The exemplary communication devices of the system 100 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 100 may include additional communication devices and communication devices of different types.

The communication devices may communicate using various wireline or wireless transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Bluetooth, IEEE 802.11, etc. A communication device may communicate using various media including, but not limited to, radio, infrared, laser, cable connection, and the like.

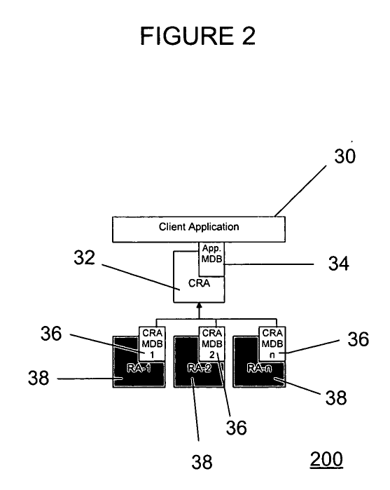

FIG. 2 shows a system 200 in which the present invention can be employed utilizing the CRA 32. The client application performs the application as dictated by the application server. The APP MDB 34 communicates between the enterprise application 30 and the CRA 32. The CRA 32 communicates between the APP MDB 34 and the CRA MDBs 36 by forming a virtual association between the APP MDB 34 and the one or more RAs 38. The interaction between the CRA 32 and the CRAM DB can take a variety of forms, including the use of TCP/IP connections, existing messaging services, common, shared databases, and connection mechanisms. Each CRA MDB 36 communicates with its corresponding RA 38.

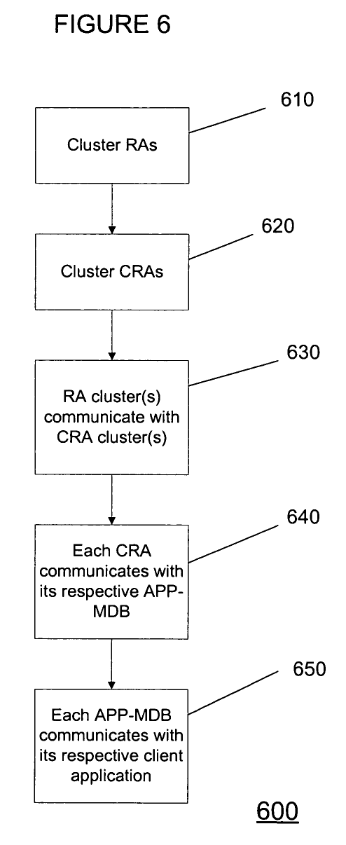

FIG. 6 shows a flow chart illustrating communication between an enterprise application 30 and one or more EISs 40 using clustered J2EE deployment and the CRA design pattern 32 according to an embodiment of the present invention. At step 610, one or more RAs 38 are grouped into clusters. RAs can be clustered such that only similar RAs are within the same cluster. As used herein, the term “similar,” as it refers to similar RAs means RAs that deliver like type of data. For example, if RAs 38 operate according to different SMS messaging protocols but the actual messages from the RAs 38 are always SMS messages, then the RAs 38 are similar. Furthermore, the base clustering can be even more specific than this example. For example, a user may have a large application which uses SMSC connections, where a first operator enables five connections while a second operation enables seven connections. In this instance, three different clusters may be used, with a first cluster having a five nodes, a second cluster having seven nodes, and a third cluster hosting the actual application. Additionally, the user may also combine the first two clusters into a seven-node cluster, where only five nodes are configured to connect to the first operator and all seven nodes are configured to connect to the second operator.

At step 620, one or more CRAs 32 are clustered. CRAs 32 can be clustered according to any number of different types of criteria as dictated by the goal of clustering and the system operation. At step 630, one or more clusters of RAs 38 that were formed at step 610 communicate with one or more clusters of CRAs 32 that were formed at step 620. At step 640, each CRA 32 communicates with its respective APP MDB 34. At step 650, each APP MDB 34 communicates with its respective client application, which operates as dictated by the enterprise application 30.

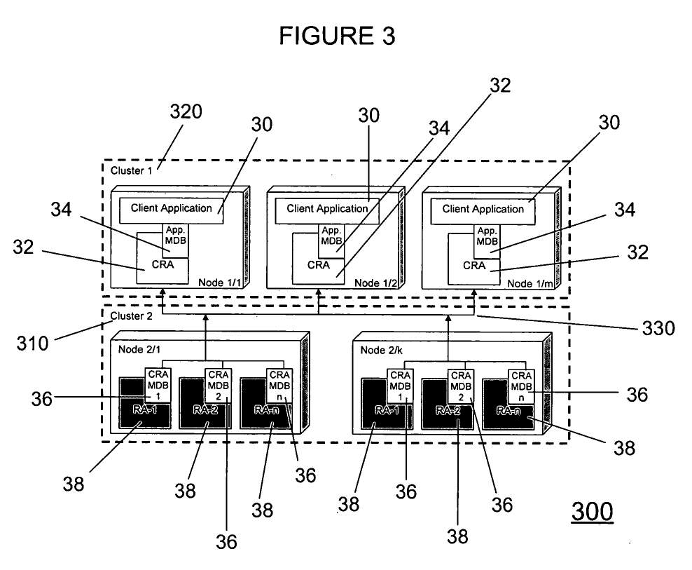

FIG. 3 shows a system 300 in which the present invention can be employed utilizing a clustered J2EE deployment. A cluster of RAs 38 is shown at 310. RAs 38 can be clustered such that any similar RAs are within the same cluster. A cluster of CRAs 32 is shown at 320. CRAs 32 can be clustered according to any number of different types of criteria as dictated by the goal of clustering and the system operation. The communication between a cluster of the CRA MDBs 36 and the CRAs 32 is represented at 330. A single CRA MDB 36 can represent all of the RAs of a cluster 310. Each APP MDB 34 communicates with a single CRA 32 and the client application 350, which has functionality as dictated by the enterprise application 30. The client application is shown at 350 and communicates with the APP MDB 34, as dictated by the enterprise application 30.

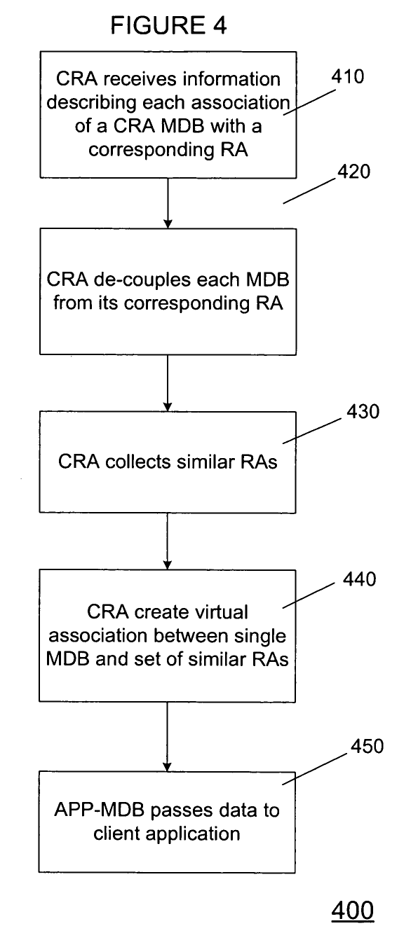

FIG. 4 shows a flow chart 400 illustrating a method of enabling communication between an application server 30 and one or more EIS devices 40 utilizing the CRA design pattern according to an embodiment of the present invention. At step 410, the CRA receives information describing each association of a CRA MDB 36 with a corresponding RA 38. At step 420, the CRA 32 de-couples each CRA MDB 36 from the RA 38 to which it has been associated via the standard operation of the RA 38, as dictated by the J2EE Connector Architecture Specification, version 1.5. At step 430, the CRA 32 collects all similar RAs 38. At step 440, the CRA 32 creates a virtual association between similar RAs 38 and a single APP MDB 34. At step 450, the APP MDB 34 transmits data, which can include but is not limited to data associated with SMS or MMS messages, to the client application, which operates as dictated by the enterprise application 30. The steps in the method are not in a fixed order and can be re-ordered to facilitate communication from the application server to the EIS 40. It should be noted that a different CRA 32 is created for each different type of EIS. For example, a SMS Messaging CRA can be used to send and receive messages, and another CRA can be used for querying a mobile device location. In this instance, the SMS Messaging CRA connects to RAs implementing messaging protocols, while the other CRA covers RAs implementing location query protocols.

An embodiment of the present invention can be described in the general context of method steps, as illustrated in FIG. 4 and FIG. 6, which may be implemented by a computer program product including computer-executable instructions, such as program code, executed by computers in wireless and wireline networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

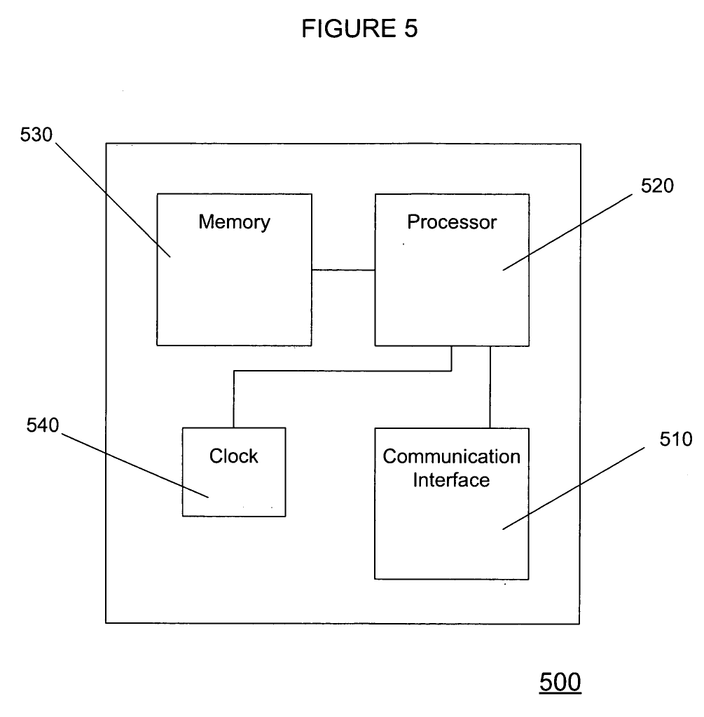

FIG. 5 shows an exemplary device 500 that can perform an embodiment of the present invention described in the general context of method steps, as illustrated in FIG. 4 and FIG. 6. The device can comprise a communication interface 510, a processor 520, a memory 530 and a clock 540. The processor 520 may retrieve a set of instructions from memory 530 and copy the instructions in an executable form to a temporary memory such as RAM or the like.

The memory 530 is the electronic holding place for the operating system so that the information can be accessed by the processor 520. The device may have a plurality of different types of memories 530 using different technologies including, but not limited to, Random Access Memory (RAM), Read Only Memory (ROM) and flash memory.

The communication interface 510 allows the CRA 32 to communicate with the outside world and other networked devices including, but not limited to, the APP MDB 34 and the CRA MDB 36. A communication interface can include, but is not limited to a serial port, an antenna, a screen with an electronic keypad, a physical keypad or a serial port. The communication interface can be accessed by a user or another device. The internal clock 540 determines how fast the processor operates; the shorter the cycle, the faster the processor operates.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of using a covered resource adapter to enable communication between electronic devices, comprising:
receiving information describing each association of a covered resource adapter message driven bean with a corresponding resource adapter;
de-coupling each covered resource adapter message driven bean from its corresponding resource adapter;
collecting all similar resource adapters; and
creating a virtual association between similar resource adapters and an application message driven bean.

2. The method of claim 1, further comprising transmitting data to a client application.

3. The method of claim 1, wherein each of the resource adapters are clustered into a plurality of clusters, and wherein each of the resource adapters are collected by the covered resource adapter.

4. The method of claim 1, wherein the data transmitted to the client application comprises short messaging service data.

5. The method of claim 1, wherein the data transmitted to the client application comprises multimedia messaging service data.

6. A computer program product for enabling communication between electronic devices, comprising:
computer code for receiving information describing each association of a covered resource adapter message driven bean with a corresponding resource adapter;
computer code for de-coupling each covered resource adapter message driven bean from its corresponding resource adapter;
computer code for collecting all similar resource adapters; and
computer code for creating a virtual association between similar resource adapters and an application message driven bean.

7. The computer program product of claim 6, further comprising computer code for transmitting data to a client application.

8. The computer program product of claim 6, further comprising computer code for clustering each of the resource adapters into a plurality of clusters, and wherein each of the resource adapter is collected by the covered resource adapter.

9. The computer program product of claim 6, further comprising computer code for clustering a plurality of covered resource adapters into clusters.

10. The computer program product of claim 6, wherein the data transmitted to the client application comprises short messaging service data.

11. The computer program product of claim 6, wherein the data transmitted to the client application comprises multimedia messaging service data.

12. An electronic device to enable communication between electronic devices, comprising:
a communication interface operatively connected to a processor;
a memory unit operatively connected to the processor and including a computer program product comprising:
computer code for receiving information describing each association of a covered resource adapter message driven bean with a corresponding resource adapter;
computer code for de-coupling each covered resource adapter message driven bean from its corresponding resource adapter;
computer code for collecting all similar resource adapters; and
computer code for creating a virtual association between similar resource adapters and an application message driven bean.

13. The electronic device of claim 12, wherein the computer program product further comprises computer code for transmitting data to a client application.

14. The electronic device of claim 12, wherein the computer program product further comprises computer code for clustering the covered resource adapters into a plurality of clusters.

15. The electronic device of claim 12, wherein the computer program product further comprises
computer code for clustering the resource adapters into a plurality of clusters, wherein each of the resource adapters are collected by the covered resource adapter.

16. The electronic device of claim 12, wherein the data transmitted to the client application comprises short messaging service data.

17. The electronic device of claim 12 wherein the data transmitted to the client application comprises multimedia messaging service data.

18. The electronic device of claim 12, wherein at least one of the electronic devices to which the electronic device enables communication comprises a database management system.

19. The electronic device of claim 12, wherein at least one of the electronic devices to which the electronic device enables communication comprises data processing software.
